(19) United States
(12) Patent Application Publication
(10) Pub. No.: US 2005/0240000 A1
(43) Pub. Date: Oct. 27, 2005

(54) Dendritic macromolecule with improved polyether polyol solubility and process for production thereof

(75) Inventors: Bo Haggman, Lund (SE); Hakan Bjornberg, Angelholm (SE)

Correspondence Address: STEVENS DAVIS MILLER & MOSHER, LLP, 1615 L STREET, NW, SUITE 850, WASHINGTON, DC, 20036, US

(73) Assignee: PERSTORP AB, Perstorp (SE)

(21) Appl. No.: 11/158,062

(22) Filed: Jun. 22, 2005

Related U.S. Application Data
(63) Continuation of application No. 10/343,046, filed on Mar. 13, 2003.
(60) Provisional application No. 60/221,512, filed on Jul. 28, 2000.

(51) Int. Cl. C08G 69/26

(52) U.S. Cl. 528/392

(57) ABSTRACT

A dendritic macromolecule having the following characteristics (i) an active hydrogen content of a least 3.8 mmoles/g and (ii) an active hydrogen functionality of at least 16 and which macromolecule is mixable at a ratio of at least 15% by weight with a polyether polyol having a hydroxyl value of at most 40 mg KOH/g to form a stable liquid at 23 ° C. The subject dendritic macromolecule confer significant load building properties to isocyanate based foams and elastomers such as polyurethane foams and elastomers and may be used for this purpose to partially or fully displace current relatively expensive chemical systems which are used to confer load building characteristics to such foams and elastomers.

In one aspect, the present invention relates to a dendritic macromolecule. Preferably, the macromolecule comprises a nucleus or initiator from which one or more chain extenders form a branched structure corresponding to at least one generation (as defined below). In a preferred embodiment, the dendritic macromolecule is terminated by means of at least one chain stopper. In a further aspect, the present invention relates to a composition comprising the subject dendritic macromolecule.

Dendritic macromolecules, including dendrimers, can generally be described as three dimensional highly branched molecules having a treelike structure. Macromolecules designated as dendritic or sometimes hyperbranched macromolecules may, to a certain degree, hold an asymmetry, yet maintaining the highly branched treelike structure. Dendrimers generally are highly symmetric. Dendrimers can be said to be monodisperse variations of dendritic macromolecules. Dendritic macromolecules normally consists of an initiator, core or nucleus having one or more reactive sites and a number of branching layers and, optionally, a layer of chain terminating molecules. The layers are usually called “generations”, a designation used throughout this specification.

The composition of dendrimers, monodisperse dendritic macromolecules, having two branching generations can be illustrated by below Formulæ (I) and (II): 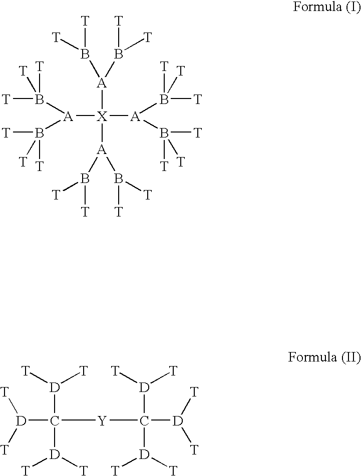
wherein: X and Y each is an initiator, core or nucleus having four and two reactive sites, respectively; A, B, C and D are chain extenders having three (A and B) and four (C and D) reactive sites, each chain extender forming one generation in the macromolecule; and T is either a terminating chain stopper or a suitable terminal functionality, consisting of for instance hydroxyl, carboxyl or epoxide groups, or a combination thereof. T may be for instance a moiety of a saturated or unsaturated compound, such as an air drying fatty acid or a derivative thereof.

As a result of their symmetrical or near symmetrical highly branched structures, dendritic macromolecules of the polyester type are characterised by having useful advantages over ordinary polyesters. Dendritic polyesters exhibit a low polydispersity especially in comparison to branched, but also linear, polyesters. A dendritic macromolecule can, due to its structure, be designed to give a very high molecular weight and yet exhibit a very low viscosity, thus being suitable as component in compositions such as coatings and the like in order to increase the solid content.

Various dendritic macromolecules are, inter alia, described in:
Tomalia et al, Angew. Chem. Int. Ed. Engl. 29 pages 138-175 (190);
U.S. Pat. No. 5,418,301 to Hult el al;
U.S. Pat. No. 5,663,247 to Sörensen et al;
International Publication no. WO 96/1532 —Perstorp AB.

Tomalia et al discloses the preparation of polyamide amines of the dendrimer type. NH₃ is used as the initiator molecule, and methyl acrylate and ethylene diamine as the chain extenders. The resultant dendrimers are NH₂ terninated. Chain stoppers are not used.

U.S. Pat. No. 5,418,301 discloses a dendritic macromolecule of the polyester type. The macromolecule includes as monomeric or polymeric initiator or nucleus a compound having one or more reactive hydroxyl groups and as chain extender a hydroxyfunctional carboxylic acid having at least one carboxyl group and at least two hydroxyl groups.

U.S. Pat. No. 5,663,247 discloses a dendritic (hyperbranched) macromolecule of the polyester type comprising a monomeric or polymeric nucleus and at least one generation of a branching chain extender having at least three reactive sites of which at least one is a hydroxyl group and at least one is a carboxyl or terminal epoxide group. The nucleus is an epoxide compound having at least one reactive epoxide group. The macromolecules disclosed by U.S. Pat. No. 5,663,247 are particularly advantageous in that they enhance various film properties, for instance drying time, hardness and scratch resistance, of a coating composition in which they i.a. are used.

The macromolecules of U.S. Pat. No. 5,418,301 and U.S. Pat. No. 5,663,247 are stated as being useful in a number of applications, including in the preparation of products constituting or being part of alkyds, alkyd emulsions, saturated polyesters, unsaturated polyesters, epoxy resins, phenolic resins, polyurethane resins, polyurethane foams and elastomers, binders for radiation curing systems such as systems cured with ultraviolett (UV) light, infrared (IR) light or electron-beams (EB), dental materials, adhesives, synthetic lubricants, microlithographic coatings and resists, binders for powder systems, amino resins, composites reinforced with glass, aramide or carbon/graphite fibres and moulding compounds based on urea-formaldehyde resins, melamine-formaldehyde resins or phenol-formaldehyde resins.

While the macromolecules of U.S. Pat. No. 5,418,301 and U.S. Pat. No. 5,663,247 are significant advances in the art, there is still room for improvements, particularly in the application of the macromolecules in isocyanate based flexible and semi-rigid foams and elastomers. Specifically, the specific macromolecules taught by U.S. Pat. No. 5,418,301 and U.S. Pat. No. 5,663,247 are difficult to handle when producing commercial quantities of isocyanate based foams, such as polyurethane foams. The principal reason for this is the relatively poor solubility in polyether polyols having a hydroxyl value of said macromolecules at high active hydrogen functionality and molecular weight.

Accordingly, it would be highly desirable to have a convenient means for incorporation of dendritic macromolecules in a polyurethane foam matrix. More particularly, it would be very advantageous to be able to incorporate into the polyurethane foam matrix a dendritic macromolecule having a combination of high active hydrogen content, high active hydrogen functionality and which may be readily processed in a polyurethane foam production facility.

It is an object of the present invention to provide a novel dendritic macromolecule which obviates or mitigates at least one of the above-mentioned disadvantages of the prior art.

Accordingly, the present invention disclose a novel group of dendritic macromolecules which may be conveniently incorporated in polyurethane foams. Surprisingly and unexpectedly, it has been further found that said novel group of dendritic macromolecules confer significant load building properties to a polyurethane foam matrix and may be used for this purpose to partially or fully displace current relatively expensive chemical systems which are used to confer load building characteristics to polyurethane foams. This effect will be illustrated below in the embodiment Examples.

A feature of the present dendritic macromolecule is that at least 15% by weight of the dendritic macromolecule may be mixed with a polyether polyol having a hydroxyl value of 40 or less than 40 to form a stable liquid at 23° C. As used throughout this specification, the term “stable liquid”, when used in connection with the solubility characteristics of the dendritic macromolecule, is intended to mean that the liquid formed upon mixing the dendritic macromolecule and the polyether polyol has a substantially constant light transmittance (transparent at one extreme and opaque at the other extreme) for at least 2 hours, preferably at least 30 days, more preferably a number of months, after production of the mixture. Practically, in one embodiment, the stable liquid will be in the form of a clear, homogeneous liquid (e.g., a solution) which will remain as such over time. In another embodiment, the stable liquid will be in the form of an emulsion of the dendritic macromolecule in the polyol which will remain as such over time—i.e. the dendritic macromolecule will not settle out over time.

Accordingly, in one of its aspects, the present invention provides a dendritic macromolecule having the following characteristics:
i) an active hydrogen content of least 3.8 or preferably at least 4, such as an active hydrogen content in the range of 3.8-10, 3.8-7, 4-8 or 4.4-5.7, mmoles/g;
ii) an active hydrogen finctionality of at least 16 or preferably at least 18, such as 16-70, 18-60, 17-35 or 20-30;
   and which macromolecule is mixable at an amount of at least 15%, such as 15-50%, 15-40% or 15-30%, by weight with a polyether polyol having a hydroxyl number of at most 40, such as 35-40 or 28-32, mg KOH/g to form a stable liquid at 23° C.

As used throughout this specification, the term “active hydrogen functionality” is intended to mean the number of active hydrogen moieties per molecule of the dendritic macromolecule.

The general architecture of the present dendritic macromolecule is similar to other such macromolecules.

Specifically, the present dendritic macromolecule may be derived from: (a) a monomeric or polymeric initiator, (b) at least one inherently branched structure comprising at least one generation of at least one branching monomeric or polymeric chain extender having a plurality of reactive sites comprising an active hydrogen containing moiety, and (c) optionally, at least one monomeric or polymeric chain stopper terminating the macromolecule. The monomeric or polymeric initiator is chemically bonded to said inherently branched structure.

The monomeric or polymeric initiator included in the dendritic macromolecule of the present invention is not particularly restricted and, in a preferred embodiment, is suitably selected from the groups of monomeric or polymeric initiators and nuclei disclosed in U.S. Pat. No. 5,418,301 and U.S. Pat. No. 5,663,247 referred to above and the content of each of which are hereby incorporated by reference.

The chain extender(s) included in the dendritic macromolecule of the present invention is not particularly restricted and, in a preferred embodiment, is suitably selected from the groups of chain extenders disclosed in U.S. Pat. No. 5,418,301 and U.S. Pat. No. 5,663,247 referred to above and the content of each of which are hereby incorporated by reference.

The chain stopper, if used, in the dendritic macromolecule of the present invention is not particularly restricted and, in a preferred embodiment, is suitably selected from the groups of chain stoppers disclosed in U.S. Pat. No. 5,418,301 and U.S. Pat. No. 5,663,247 referred to above and the content of each of which are hereby incorporated by reference.

The present dendritic macromolecules may be of the so-called ester type, for example, as disclosed in U.S. Pat. No. 5,418,301 and U.S. Pat. No. 5,663,247. Alternatively, the present dendritic macromolecule may be of the so-called ether type, for example, as disclosed by Magnusson et al in Macromol. Rapid Commun. 20, 453-457 (1999).

Further, the dendritic macromolecule need not necessarily include a monomeric or polymeric nucleus or initiator. Specifically, the macromolecule may be a polymer derived directly from the chain extender(s). Dendritic macromolecules derived directly from a chain extender is illustrated in Example 7, wherein a dendritic macromolecule is produced from trimethylolpropane oxetane. Further dendritic macromolecules derived directly from a chain extender can be exemplified by polycondensation of one or more hydroxyfunctional carboxylic acids, such as 2,2-dimethylolpropionic acid

Embodiments of the dendritic macromolecule of the present invention include species wherein the active hydrogen is present in said macromolecule in form of one or more mercapto moieties, one or more primary amino moieties, one or more secondary amino moieties, one or more hydroxyl moieties or in form of two or more moieties selected from the group consisting of a mercapto moiety, a primary amino moiety, a secondary amino moiety, a hydroxyl moiety and any combination thereof.

A dendritic macromolecule having primary amino moieties can suitably be obtained in a process comprising the Steps of:

i) subjecting a hydroxyfunctional dendritic polyether having one or more hydroxyl groups to alkolation by:
a) mixing said polyether and a suitable solvent, such as tetrahydrofuran, and
b) adding, preferably when a clear solution is obtained, in stoichiometric amount or in slight excess a base, such as NaOH, KOH and/or NaH;

ii) subjecting in Step (i) obtained alkolate to nitrilation by addition of said alkolate to acrylonitrile unsaturation, said acrylonitrile being charged in a stoichiometric amount with regard to moles of said alkolate, whereby said alkolate is converted to a nitrile functional dendritic polymer of polyether type; and

iii) converting said nitrile functional dendritic polymer to an amine functional dendritic polymer of polyether type by:
a) reducing pH of in Step (ii) obtained reaction mixture by addition of protons;
b) passing H₂ through said reaction mixture in presence of a reducing catalyst, such as Pt, Pd and/or Raney Ni neat or fixated to a carrier such as a carbon carrier, and subsequently recovering obtained amine functional dendritic polymer of polyether type.
   or in a process comprising the Steps of:

i) subjecting a hydroxyfunctional dendritic polyester to acrylation at a ratio COOH:OH of 0.1:1 to 1:1;

ii) reacting in Step (i) obtained acrylated product with at least one primary aliphatic, cycloaliphatic or aromatic amine, such as propyl amine, isopropylamine, octyl amine, butyl amine or benzyl amine, said amine being charged in a stoichiometric amount or in excess to said acrylated product and said reaction being performed at room temperature or an elevated temperature, such as 50° C., and subsequently recovering obtained amine functional dendritic polymer of polyester type.

See also Examples 11 and 12 for further details on above subject matter of the present invention.

Said macromolecule has in its embodiments an inherently branched structure, such as a plurality of inherently branched structures chemically bonded to one another, which inherently branched structure may comprise one or more monomeric or polymeric moieties selected from the group consisting of an ester moiety, an ether moiety, an amine moiety, an amide moiety and any combination thereof, such as at least one ester moiety, optionally combined with at least one ether moiety or at least one ether moiety, optionally combined with at least one ester moiety. Said inherently branched structure may further comprise at least one, such as two or more different, monomeric or polymeric chain stopper moiety/moieties chemically bonded thereto. Said inherently branched structure may yet further comprise at least one monomeric or polymeric spacing chain extender chemically bonded thereto.

As will be developed herein below in the embodiment Examples (see particularly Example 7), it is possible to select the chain extender to achieve a dendritic macromolecule having solubility parameters set out above, without the need for the use of a chain stopper.

In a further aspect the present invention refers to a composition comprising at least 15% by weight of the dendritic macromolecule disclosed above and at most 85%, such as 15-75%, 30-50% or 35-45%, by weight of a polyether polyol having a hydroxyl value of 40 or at most 40 mg KOH/g.

Embodiments of the present invention will be disclosed with reference to Examples 1-17 which are provided for illustrative purposes only and should not be used to construe or limit the scope of the invention. Examples 1-7 and 11-12 illustrate production and derivatisation of dendritic macromolecules, Example 8-10 disclose solubility evaluations of the macromolecules of Examples 1-7, and Examples 13-17 illustrate the use of the subject dendritic macromolecule in a typical isocyanate based foam.

### EXAMPLE 1 (COMPARATIVE)

100.0 kg of an alkoxylated pentaerythritol (Perstorp Specialty Chemicals) with a hydroxyl value of 630 mg KOH/g, 1055 kg of 2,2-dimethylolpropionic acid (Bis-MPA, Perstorp Specialty Chemicals) and 8.5 kg of p-toluenesulphonic acid were cold mixed in a reactor equipped with a heating system with accurate temperature control, a mechanical stirrer, a pressure gauge, a vacuum pump, a cooler, nitrogen inlet and a receiver. The mixture was heated carefully during slow stirring to a temperature of 140° C. Slow stirring of the mixture at this temperature was maintained at atmospheric pressure until all 2,2-dimethylolpropionic acid was dissolved and the reaction mixture formed a fully transparent solution. The stirring speed was then significantly increased and vacuum was applied to a pressure of 30 mbar. Reaction water immediately started to form, which was collected in the receiver. The reaction was allowed to continue for a further 7 hours, until a final acid value of ≈9 mg KOH/g was obtained. This corresponded to a chemical conversion of ≈98%.

The obtained dendritic polymer had the following characteristics:

| | |
|---|---|
| Final acid value: | 8.9 mg KOH/g |
| Final hydroxyl value: | 489 mg KOH/g |
| Peak molecular weight: | 3490 g/mole |
| Mw (SEC): | 3520 g/mole |
| Mn (SEC): | 2316 g/mole |
| PDI (Mw/Mn): | 1.52 |
| Average hydroxyl functionality: | 30.4 hydroxyl groups/molecule |

The obtained properties were in good agreement with the expected theoretical molecular weight of 3607 g/mole at 100% chemical conversion and the theoretical hydroxyl value of 498 mg KOH/g, which correspond to a hydroxyl functionality of 32.

### EXAMPLE 2 (COMPARATIVE)

16.7 kg of an alkoxylated pentaerythritol (Perstorp Specialty Chemicals) with a hydroxyl value of 630 mg KOH/g, 375.0 kg of 2,2-dimethylolpropionic acid (Bis-MPA, Perstorp Specialty Chemicals) and 3.0 kg of p-toluenesulphonic acid were cold mixed in a reactor equipped with a heating system with accurate temperature control, a mechanical stirrer, a pressure gauge, a vacuum pump, a cooler, nitrogen inlet and a receiver. The mixture was heated carefully during slow stirring to a temperature of 140° C. Slow stirring of the mixture at this temperature was maintained at atmospheric pressure until all 2,2-dimethylolpropionic acid was dissolved and the reaction mixture formed a fully transparent solution. The stirring speed was then significantly increased and vacuum was applied to a pressure of 30 mbar. Reaction water immediately started to form, which was collected in the receiver. The reaction was allowed to continue for a further 8 hours, until a final acid value of ≈12 mg KOH/g was obtained. This corresponded to a chemical conversion of ≈97%.

The obtained dendritic polymer had the following characteristics:

| | |
|---|---|
| Final acid value: | 11.9 mg KOH/g |
| Final hydroxyl value: | 481 mg KOH/g |
| Peak molecular weight: | 5110 g/mole |
| Mw (SEC): | 5092 g/mole |
| Mn (SEC): | 3041 g/mole |
| PDI (Mw/Mn): | 1.67 |
| Average hydroxyl functionality: | 43.8 hydroxyl groups/molecule |

The obtained properties were in reasonable agreement with the expected theoretical molecular weight of 7316 g/mole at 100% chemical conversion and the theoretical hydroxyl value of 491 mg KOH/g, which correspond to a hydroxyl functionality of 64.

### EXAMPLE 3 (COMPARATIVE)

83.6 kg of an alkoxylated pentaerythritol (Perstorp Specialty Chemicals) with a hydroxyl value of 630 mg KOH/g, 375.0 kg of 2,2-dimethylolpropionic acid (Bis-MPA, Perstorp Specialty Chemicals) and 3.25 kg ofp-toluenesulphonic acid were cold mixed in a reactor equipped with a heating system with accurate temperature control, a mechanical stirrer, a pressure gauge, a vacuum pump, a cooler, nitrogen inlet and a receiver. The mixture was heated carefully during slow stirring to a temperature of 140° C. Slow stirring of the mixture at this temperature was maintained at atmospheric pressure until all 2,2-dimethylolpropionic acid was dissolved and the reaction mixture formed a fully transparent solution. The stirring speed was then significantly increased and vacuum was applied to a pressure of 30 mbar. Reaction water immediately started to form, which was collected in the receiver. The reaction was allowed to continue for a further 7.5 hours, until an acid value of ≈5 mg KOH/g was obtained. This corresponded to a chemical conversion of ≈98%.

The obtained dendritic polymer had the following characteristics:

| | |
|---|---|
| Final acid value: | 4.7 mg KOH/g |
| Final hydroxyl value: | 508 mg KOH/g |
| Peak molecular weight: | 1998 g/mole |
| Mw (SEC): | 1997 g/mole |
| Mn (SEC): | 1451 g/mole |
| PDI (Mw/Mn): | 1.37 |
| Average hydroxyl functionality: | 18 hydroxyl groups/molecule |

The obtained properties were in good agreement with the expected theoretical molecular weight of 1750 g/mole at 100% chemical conversion and the theoretical hydroxyl value of 513 mg KOH/g, which correspond to a hydroxyl functionality of 16.

### EXAMPLE 4

25 kg of the dendritic polymer according to Example 1, 8.4 kg of an aliphatic acid with nine carbon atoms having an acid number of 363 mg KOH/g and 3.3 kg of xylene were charged to a reactor equipped with a heating system with accurate temperature control, a mechanical stirrer, a pressure gauge, a vacuum pump, a Dean-Stark device for azeotropic removal of water, a cooler, nitrogen inlet and a receiver. The mixture was heated under stirring, with a nitrogen flow of 500-600 l/h through the reaction mixture, from room temperature to 170° C. At this temperature all xylene was refluxing and the reaction water which started to form was removed by azeotropic distillation. The reaction was allowed to continue for a further 1.5 hours at 170° C., after which the reaction temperature was increased to 180° C. The reaction mixture was kept at this temperature for a further 2.5 hours until an acid value of ≈6 mg KOH/g was obtained. Full vacuum was then applied to the reactor to remove all xylene from the final product.

The obtained derivatised dendritic polymer had the following characteristics:

| | |
|---|---|
| Final acid value: | 6.2 mg KOH/g |
| Final hydroxyl value: | 293 mg KOH/g |
| Peak molecular weight: | 4351 g/mole |
| Mw (SEC): | 4347 g/mole |
| Mn (SEC): | 1880 g/mole |
| PDI (Mw/Mn): | 2.31 |
| Average hydroxyl functionality: | 22.7 hydroxyl groups/molecule |

The obtained properties were in reasonable agreement with the expected theoretical molecular weight of 4699 g/mole at 100% chemical conversion and the theoretical hydroxyl value of 287 mg KOH/g, which correspond to a hydroxyl functionality of 24.

### EXAMPLE 5

25 kg of the dendritic polymer according to Example 3, 5.25 kg of an aliphatic acid with nine carbon atoms having an acid number of 363 mg KOH/g and 3.0 kg of xylene were charged to a reactor equipped with a heating system with accurate temperature control, a mechanical stirrer, a pressure gauge, a vacuum pump, a Dean-Stark device for azeotropic removal of water, a cooler, nitrogen inlet and a receiver. The mixture was heated under stirring, with a nitrogen flow of 500-600 l/h through the reaction mixture, from room temperature to 180° C. At this temperature all xylene was refluxing and the reaction water which started to form was removed by azeotropic distillation. The reaction was allowed to continue for a further 5 hours at 180° C. until an acid value of ≈6 mg KOH/g was reached. Full vacuum was then applied to the reactor to remove all xylene from the final product.

The obtained derivatised dendritic polymer had the following characteristics:

| | |
|---|---|
| Final acid value: | 6.0 mg KOH/g |
| Final hydroxyl value: | 360 mg KOH/g |
| Peak molecular weight: | 2700 g/mole |
| Mw (SEC): | 2733 g/mole |
| Mn (SEC): | 1673 g/mole |
| PDI (Mw/Mn): | 1.61 |
| Average hydroxyl functionality: | 17.3 hydroxyl groups/molecule |

The obtained properties were in reasonable agreement with the expected theoretical molecular weight of 2080 g/mole at 100% chemical conversion and the theoretical hydroxyl value of 367 mg KOH/g, which correspond to a hydroxyl finctionality of 13.6.

### EXAMPLE 6

25 kg of the dendritic polymer according to Example 2, 8.3 kg of an aliphatic acid with nine carbon atoms having an acid number of 363 mg KOH/g and 3.3 kg of xylene were charged to a reactor equipped with a heating system with accurate temperature control, a mechanical stirrer, a pressure gauge, a vacuum pump, a Dean-Stark device for azeotropic removal of water, a cooler, nitrogen inlet and a receiver. The mixture was heated under stirring, with a nitrogen flow of 500-600 l/h through the reaction mixture, from room temperature to 180° C. At this temperature all xylene was refluxing and the reaction water which started to form was removed by azeotropic distillation. The reaction was allowed to continue for a further 5 hours at 180° C. until an acid value of ≈7 mg KOH/g was reached. Full vacuum was then applied to the reactor to remove all xylene from the final product.

The obtained derivatised dendritic polymer had the following characteristics:

| Final acid value: | 6.8 mg KOH/g |
|---|---|
| Final hydroxyl value: | 280 mg KOH/g |
| Peak molecular weight: | 5274 g/mole |
| Mw (SEC): | 5245 g/mole |
| Mn (SEC): | 2428 g/mole |
| PDI (Mw/Mn): | 2.16 |

The obtained properties were in reasonable agreement with the expected theoretical hydroxyl value of 283 mg KOH/g.

### EXAMPLE 7

200.0 g of trimethylolpropane oxetane (TMPO, Perstorp Specialty Chemicals) was charged to a reactor equipped with a mechanical stirrer, a cooler and a heating system with adequate heating control. 2.0 g of a solution of BF₃ etherate (10% in diethyl ether) was charged at room temperature to the reactor during less than 120 seconds. A strong exotherm was seen as a result of the ring opening polymerisation of the oxetane monomer. Once the exotherm faded, the reaction mixture was heated to 150° C. and kept at that temperature under stirring for a further 90 minutes. The reaction mixture was then cooled to room temperature at which the final product was recovered.

The obtained dendritic polymer of polyether type had the following characteristics:

| | |
|---|---|
| Final hydroxyl value: | 500 mg KOH/g |
| Peak molecular weight: | 6307 g/mole |
| Mw (SEC): | 5309 g/mole |
| Mn (SEC): | 2011 g/mole |
| PDI (Mw/Mn): | 2.64 |
| Average hydroxyl functionality: | 56 hydroxyl groups/molecule |
| Chemical conversion: | 99.4% with regard to residual |
| | monomer content |

### EXAMPLE 8 (COMPARATIVE)

The solubility of each of the dendritic polymers according to Examples 1-3 in a glycerol based polyether polyol with a hydroxyl value of 32 mg KOH/g was evaluated.

15.0 g of respective dendritic polymer according to Examples 1-3 was added to a beaker containing 75.0 g of a glycerol based polyether polyol with a hydroxyl value of 32 mg KOH/g. The mixture was heated under stirring to 120° C. during 30 minutes and then allowed to cool down to room temperature. The ability for each dendritic polymer to form a stable solution with the polyether polyol was evaluated after 120 minutes.

None of the dendritic polymers according to Examples 1-3 were able to form a stable solution with the glycerol based polyether polyol of hydroxyl value 32 mg KOH/g. The dendritic polymers according to Examples 1-3 partly precipitated from the solution and this could be observed in the form of a separate phase at the bottom of the beaker.

### EXAMPLE 9

The solubility of each of the dendritic polymers according to Examples 4-6 in a glycerol based polyether polyol with a hydroxyl value of 32 mg KOH/g was evaluated.

15.0 g of respective dendritic polymer according to Examples 4-6 was added to a beaker containing 75.0 g of a glycerol based polyether polyol with a hydroxyl value of 32 mg KOH/g. The mixture was heated under stirring to 120° C. during 30 minutes and then allowed to cool down to room temperature. The ability for each dendritic polymer to form a stable solution with the polyether polyol was evaluated after 120 minutes.

All of the evaluated dendritic polymers according to Example 4-6 were fully soluble in the glycerol based polyether polyol. Fully transparent solutions were obtained in all cases, which were stable over time. Due to the excellent solubility, samples of higher concentrations based on the products obtained according to Examples 4-6 were prepared. These were then evaluated with regard to viscosity at 23° C. Samples of different concentrations of dendritic polymer according to Examples 4-6 in polyether polyol were prepared and found to be fully compatible with the base glycerol based polyether polyol. These stable solutions remained as such even after 30 days.

The attached FIG. 1 illustrates the viscosity dependence in a polyether polyol of products according to Examples 4-6. As can be seen from the results illustrated in the attached FIG. 1, very good behaviour of the products according to Examples 4-6 were obtained.

### EXAMPLE 10

The solubility of the dendritic polymer of polyether type according to Example 7 in a glycerol based polyether polyol with a hydroxyl value of 32 mg KOH/g was evaluated.

15.0 g of the dendritic polymer according to Example 7 was added to a beaker containing 75.0 g of a glycerol based polyether polyol with a hydroxyl value of 32 mg KOH/g. The mixture was heated under stirring to 120° C. during 30 minutes and then allowed to cool down to room temperature. The ability for the dendritic polymer to form a stable solution with the polyether polyol was evaluated after 120 minutes.

It was found that the dendritic polymer of polyether type according to Example 7 formed an opaque but completely stable solution with the glycerol based polyether polyol.

### EXAMPLE 11

An amine terminated dendritic polymer of polyether type was prepared according to the following principal synthesis procedure:

Step 1: A dendritic polyether, such as a dendritic polymer according to Example 7, and a suitable solvent, such as tetrahydrofuran (THF), are charged to a reactor equipped with a mechanical stirrer, a heating system with adequate temperature control, a cooler, gas inlet, a vacuum pump and a receiver. When a transparent solution is obtained, a base such as NaOH, KOH or NaH is added in stoichiometric amount or with a slight excess, at which the dendritic alkolate is formed (RO⁻Na⁺).

Step 2: Acrylonitrile is added in a stoichiometric amount with regard to the moles of RO-Na⁺species present in the reaction mixture from Step 1. The alkolated species will then undergo an addition to the unsaturation of the acrylonitrile. The obtained product in Step 2 has therefore been converted to a nitrile terminated dendritic polymer of polyether type.

Step 3: The nitrile functionality of the reaction product according to Step 2 is converted to primary amines by: (i) reducing the pH of the reaction mixture by addition of protons, (ii) thereafter passing H₂ (g) through the reaction mixture in the presence of a reducing catalyst, such as Pt, Pd or Raney Ni neat or fixated (e.g. to a carbon carrier); and (ii) thereafter recovering the obtained amine functional dendritic polymer of polyether type by for instance conventional washing and/or extraction procedures.

Further details on species of these reaction steps may be found in House, H. O., “Modem Synthetic Reactions”, 16-19, Benj. Cumm. Publ. (1972).

### EXAMPLE 12

A fully or partially amine terminated dendritic polymer of polyester type was prepared according to the following principal synthesis procedure:

Step 1: A dendritic polyester, such as a polymer according to any of the Examples 1-6, acrylic acid in a ratio COOH:OH of 0.1:1 to 1:1 with regard to the hydroxyl value of the dendritic polymer and a protonic acid, such as methane sulphonic acid (≈1% by weight concentration of the total solution), one or several inhibitors for radical polymerisation (e.g. hydroquinone and/or an alkylhydroquinone) and a solvent, such as toluene or a mixture of, for example, toluene and tetrahydrofuran, are charged to a reactor equipped with a mechanical stirrer, a Dean-Stark separated, adequate temperature control, nitrogen inlet, a cooler and a receiver. The reaction mixture is heated to 100-120° C., at which point the solvent is starting to reflux and reaction (esterification) water is starting to form. The reaction is allowed to continue at said temperature until an acid value of about 5-30 mg KOH/g, preferably 5-15 mg KOH/g, is reached. The product is then used as such or further purified by either washing with a weak aqueous solution of for instance NaOH, or the residual acrylic acid is precipitated with, for example, Al₂O₃.

Step 2: The acrylated product according to Step 1 is then reacted with a primary aliphatic, cycloaliphatic or aromatic amine, such as propyl amine, isopropylamine, octyl amine, butyl amine (n-, sec-, tert-) or benzyl amine. The amine of choice is added in stoichiometric amount or in excess to the acrylated product of Step 1, at which an addition reaction to the unsaturation of the dendritic acrylate will occur. The reaction is either performed at room temperature or a slightly elevated temperature, such as 50° C. The conversion of acrylate to amine is suitably either followed by IR or NIR by the disappearance of acrylate unsaturations, or by GC analysis of the residual amine content in the mixture. Obtained amine terminated dendritic polymer of polyester type is then recovered by evaporating residual amine monomer and solvent by applying full vacuum to the reactor.

### EXAMPLES 13-17

Examples 13-17 illustrate the use of the present dendritic polymer in a typical isocyanate based high resilient (HR) based foam. In each Example, the isocyanate based foam was prepared by the pre-blending of all resin ingredients including polyols, copolymer polyols (if used), catalysts, water, and surfactants as well as the dendritic macromolecule of interest (if used). The isocyanate was excluded from the mixture. The resin blend and isocyanate were then mixed at an isocyanate index of 100 using a conventional two-stream mixing technique and dispensed into a preheated mould (65° C.) having the dimensions 38.1×38.1×10.16 cm. The mould was then closed and the reaction allowed to proceed until the total volume of the mould was filled. After approximately 6 minutes, the isocyanate based foam was removed and, after proper conditioning, the properties of interest were measured. The methodology will be referred to in Examples 13-17 as the General Procedure.

In Examples 13-17, the following materials were used:
E837, base polyol, commercially available from Lyondell;
E850, a 43% solids content copolymer (SAN) polyol, commercially available from Lyondell;
HBP, a dendritic macromolecule produced in Example 4 above;
DEAO LF, diethanol arnine, a crosslinking agent commercially available from Air Products;
Glycerine, a crosslinking agent, commercially available from Van Waters & Rogers; Water, indirect blowing agent;
Dabco 33LV, a gelation catalyst, commercially available from Air Products;
Niax A-1, a blowing catalyst, commercially available from Witco;
Y-10184, a surfactant, commercially available from Witco; and
Lupranate T80, isocyanate (toluene diisocyanate—TDI), commercially available from BASF.

Unless otherwise stated, all parts reported in Examples 13-17 are parts by weight.

In Examples 13-15, isocyanate based foams based on the formulations shown in Table 1 were produced using the General procedure referred to above.

In Examples 13-15, isocyanate based foams were prepared in the absence of any copolymer polyol. The isocyanate based foams were formulated with a H₂O concentration of 3.8% resulting in an approximate foam core density of 31 kg/m³. The level of dendritic macromolecule was varied from 6.68% to 13.35% by weight in the resin.

The results of physical property testing are reported in Table 1. Also reported in Table 1 for each foam is the density and Indentation Force Deflection (IFD) at 50% deflection, measured pursuant to ASTM D3574. As shown, the introduction of the dendritic macromolecule to the isocyanate based polymer matrix resulted in a ≈83 N hardness increase for foam from Example 13 to Example 14, and a ≈83 N hardness increase for the foam from Example 14 to Example 15.

By this analysis, a “load efficiency” for each foam may be reported and represents the ability of the dendritic macromolecule to generate firmness in the isocyanate based foam matrix. The efficiency is defined as the number of Newtons of foam hardness increase per % of the dendritic macromolecule in the resin blend. The term “load efficiency”, as used throughout this specification, is intended to have the meaning set out in this paragraph.

As shown, the introduction of the dendritic macromolecule resulted in a foam hardness increase of 181 N. The resulting load efficiency is 27 N/% dendritic macromolecule in the resin.

In Examples 16 and 17, isocyanate based foams based on the formulations shown in Table 1 were produced using the General Procedure referred to above.

In Examples 16 and 17, isocyanate based foams were prepared in the absence of any dendritic macromolecule and used only copolymer polyol as the method by which foam hardness is increased. Thus, it will be appreciated that Examples 16 and 17 are provided for comparative purposes only and are outside the scope of the present invention. The isocyanate based foams were formulated with a H₂O concentration of 3.8% resulting in an approximate foam core density of 31 kg/m³. The level of the copolymer polyol was varied from 8 to 26% by weight in the resin.

The result of physical property testing are reported in Table 1. As shown, the introduction of the copolymer resulted in a foam hardness increase of 192.1 N. The resulting load efficiency is 10.69 N/% copolymer polyol in the resin. As will be apparent, this is significantly less than the load efficiency achieved in the foams produced in Examples 13-15.

TABLE 1

| | Example | Example | Example | Example | Example |
|---|---|---|---|---|---|
| Ingredient | 13 | 14 | 15 | 16 | 17 |
| E837 | 92.8 | 89.2 | 85.6 | 34.85 | 79.95 |
| E850 | — | — | — | 65.15 | 20.05 |
| HBP | 7.2 | 10.8 | 14.4 | — | — |
| DEOA LF | 1.1 | 1.1 | 1.1 | 1.1 | 1.1 |
| Glycerin | 0.6 | 0.6 | 0.6 | 0.6 | 0.6 |
| H₂O | 3.93 | 3.93 | 3.93 | 3.93 | 3.93 |
| Dabco 33LV | 0.411 | 0.452 | 0.492 | 0.33 | 0.33 |
| Niax A-1 | 0.08 | 0.08 | 0.08 | 0.08 | 0.08 |
| Y10184 | 1 | 1 | 1 | 1 | 1 |
| Total resin | 107.12 | 107.16 | 107.20 | 107.04 | 107.04 |
| Luprate T80 | 51.737 | 53.197 | 54.658 | 40.817 | 41.432 |
| Index | 100 | 100 | 100 | 100 | 100 |
| % H₂O | 3.8 | 3.8 | 3.8 | 3.8 | 3.8 |
| % SAN | 0 | 0 | 0 | 26 | 8 |
| in resin | | | | | |
| % HBP | 6.68 | 10.01 | 13.35 | 0 | 0 |
| in resin | | | | | |
| Total dry | 476 | 471 | 473 | 550 | 556 |
| weight (g) | | | | | |
| Density | 31 | 31 | 31 | 31 | 31 |
| (kg/m³) | | | | | |
| 50% IFD (N) | 301.6 | 399.9 | 482.6 | 468.4 | 276.3 |
| % Hysteresis | 34.9 | 39.3 | 42.6 | 38.4 | 29.1 |
| Load | 27.13 | 27.13 | 27.13 | 10.69 | 10.69 |
| Efficiency | | | | | |

[image]

While this invention has been described with reference to illustrative embodiments and Examples, the description is not intended to be construed in a limiting sense. For example, while esterification/acid derivatisation and ring opening techniques were used in some of the Examples to produce embodiments of the novel dendritic macromolecule, other derivatisation techniques such as transesterification, polyaddition reactions, free radical polymerisation and the like can be used. Thus, various modifications of the illustrative embodiments, as well as other embodiments of the invention, will be apparent to persons skilled in the art upon reference to this description. It is therefore contemplated that the appended Claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

1-33. (canceled)

34. A composition comprising a dendritic polymer and a polyether polyol for incorporation in a polyurethane foam or elastomer matrix, wherein said composition comprises:
at least 15% by weight of at least one dendritic polymer selected from the group consisting of dendritic polyesters and dendritic polyethers, said dendritic polymer having an active hydrogen functionality of at least 16 and an active hydrogen content of at least 3.8 mmoles/g, and said active hydrogen being present in a form of one or more primary or secondary amino groups, optionally in combination with one or more primary or secondary hydroxyl groups; and
at most 85% by weight of at least one polyether polyol having a hydroxyl value of at most 40 mg KOH/g.

35. A composition according to claim 34, wherein said dendritic polymer is obtained by addition to a hydroxyfunctional dendritic polyester or polyether, which dendritic polyester or polyether optionally is at least partially chain terminated by addition of at least one monomeric or polymeric chain stopper, of at least one compound providing said dendritic polymer with said one or more primary or secondary amino groups.

36. A composition according to claim 34, wherein said dendritic polymer has an active hydrogen content of at least 4, and an active hydrogen functionality of at least 18.

37. A composition according to claim 34, wherein said dendritic polymer has an active hydrogen functionality of between 18 and 60.

38. A composition according to claim 34, wherein said dendritic polymer has an active hydrogen functionality of between 17 and 35.

39. A composition according to claim 34, wherein said dendritic polymer has an active hydrogen functionality of between 20 and 30.

40. A composition according to claim 34, wherein said dendritic polymer has an active hydrogen content of between 4 and 8 mmoles/g.

41. A composition according to claim 34, wherein said dendritic polymer has an active hydrogen content of between 4.4 and 5.7 mmoles/g.

42. A composition according to claim 34, wherein said composition comprises between 15 and 75% by weight of said dendritic polymer.

43. A composition according to claim 34, wherein said composition comprises between 30 and 50% by weight of said dendritic polymer.

44. A composition according to claim 34, wherein said composition comprises between 35 and 45% by weight of said dendritic polymer.

45. A composition according to claim 34, wherein said composition comprises between 15% and 50% by weight of said polyether polyol.

46. A composition according to claim 34, wherein said composition comprises between 15% and 40% by weight of said polyether polyol.

47. A composition according to claim 34, wherein said composition comprises between 15% and 30% by weight of said polyether polyol.

48. A composition according to claim 34, wherein said polyether polyol has a hydroxyl value of between 25 and 35 mg KOH/g.

49. A composition according to claim 34, wherein said polyether polyol has a hydroxyl value of between 28 and 32 mg KOH/g.
